(19) United States
(12) Patent Application Publication
(10) Pub. No.: US 2001/0039912 A1
(43) Pub. Date: Nov. 15, 2001

(54) Device and method for aiding in vehicular parking

(76) Inventor: Eugene Sutton, Lehigh Acres, FL (US)

Correspondence Address: Laura G. Barrow, Esq., P.O. Box 215, Estero, FL, 33928-0215, US

(21) Appl. No.: 09/851,049

(22) Filed: May 8, 2001

Related U.S. Application Data
(60) Provisional application No. 60/203,307, filed on May 10, 2000.

(51) Int. Cl. B60Q 11/00

(52) U.S. Cl. 116/28 R; 33/286

(57) ABSTRACT

A novel method for aiding a person in parking a vehicle within a desired parking area is described. In certain aspects, the invention comprises securing a reflective device, such as a mirror, to a stationary structure, such as a garage wall, for example. The reflective device has a reference point positioned on the device's reflective surface. The driver moves the vehicle within the desired parking area until the driver views the reflection of a pre-selected feature of the vehicle in alignment with the reference point of the reflective device. Once this alignment is viewed, the vehicle is stopped and thus, parked in a desired position within the parking area.

This application claims the benefit of the filing of co-pending U.S. provisional application No. 60/203,307, filed May 10, 2000 and which is incorporated by reference herein in its entirety.

It is not always a simple task to consistently park an automobile correctly or optimally within a tight parking space, such as a narrow car port or garage space. When parking a car in a residential garage, for example, there is often only a narrow space to maneuver within. Without the help of another person outside of the car to guide the driver inside, the driver often has no other means by which to park the car within the desired location. In the case of a garage, that desired position would be one that is not too far away from, or too close to, the rear wall, for example. It may also be desirable that the vehicle not be parked too close to either of the side walls so that the driver and passengers can easily exit the car without hitting the doors against the wall or articles stored within the garage.

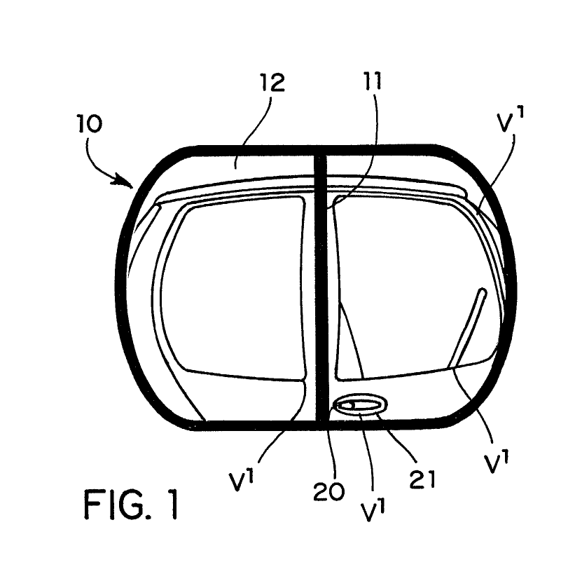

FIG. 1 is a front view of the inventive reflective device illustrating a reflection of a vehicle there from.

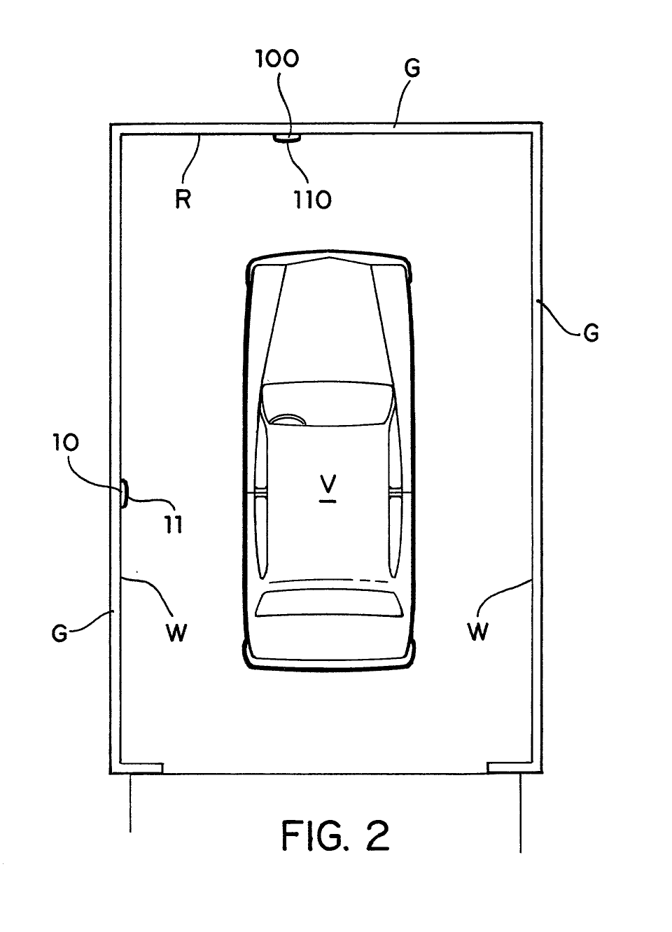

FIG. 2 is a top schematic view of a vehicle parked within a garage or car port, wherein both the rear wall and a side wall have mounted thereon the inventive reflective device.

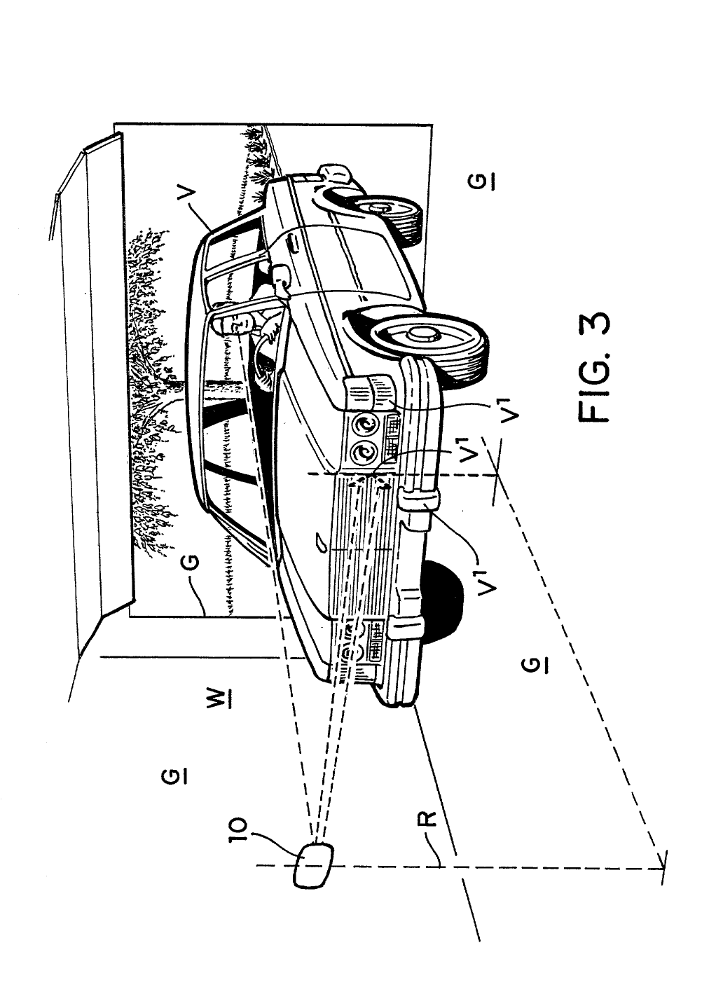

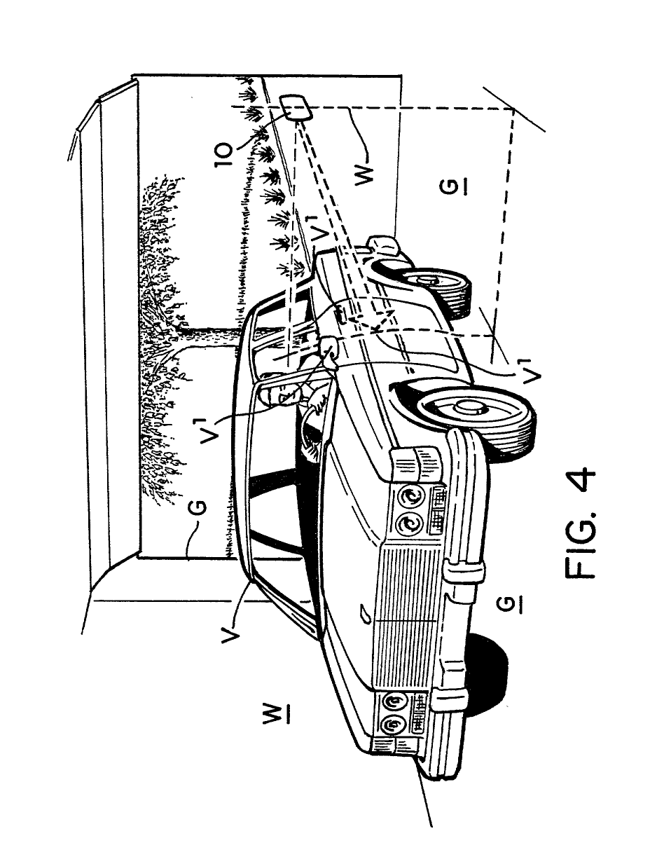

FIGS. 3-4 illustrate a vehicle positioned within a garage using the inventive mirror.

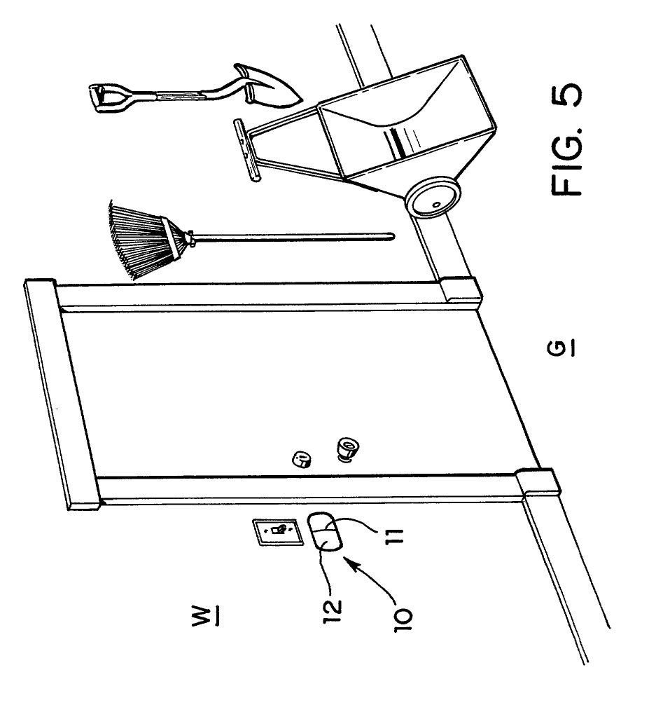

FIG. 5 is illustrates the inventive reflective device mounted on a garage wall.

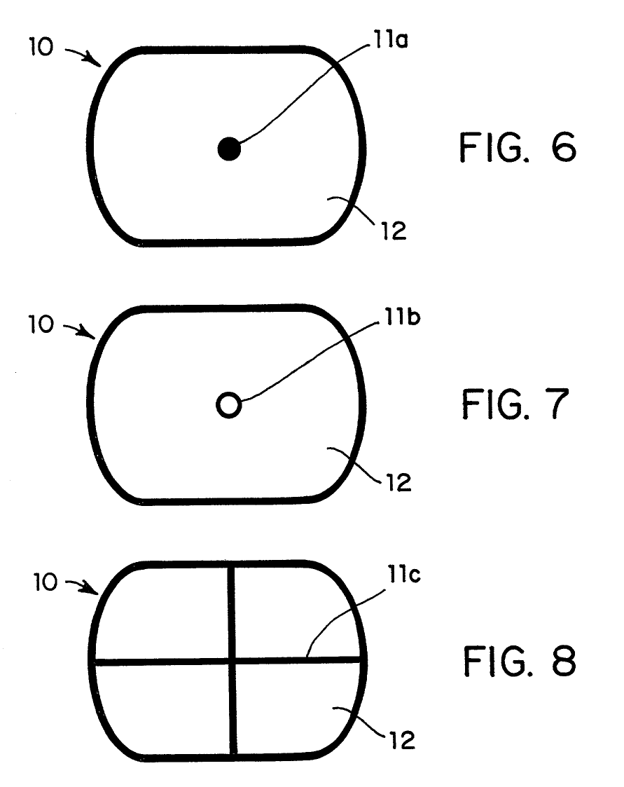

FIGS. 6-8 illustrate additional embodiments of the inventive mirror.

The present invention, in certain aspects, is directed to a device and method for aiding a driver in parking his/her vehicle consistently within a desired parking area without requiring the continual assistance of another person. In particular, the invention comprises reflective device (10), such as a conventional mirror, as illustrated in FIG. 1. The device (10) has a reflective surface (12) that may be convex and includes at least one reference point (11) positioned thereon. The reference point (11) may be a vertical line, as shown in FIG. 1, that bisects the reflective device (10). The reference point (11) may be etched into the reflective surface (12) of the mirror, drawn (e.g. painted) on the reflective surface, or affixed to the surface (12) (e.g. adhesive stickers or strips of adhesive tape affixed thereon). A reference line (11), as shown in FIG. 1, is employed and disposed such that it bisects the mirror; however, the reference line may be placed anywhere on the mirror, if desired. Instead of a vertical reference line, the reference point (11) may comprise an etching, sticker, or marking of any geometric shape (e.g. solid circle (11a), ring (11b), cross (11c), X (not shown), picture (not shown), etc.) and size placed anywhere on the reflective surface (12) of the device, as shown, for example, in FIGS. 6-8. Preferably, however, the reference point is positioned near or at the center of the device's reflective surface (12), as shown in FIG. 1. Moreover, for improved visibility, especially at night, it may be desirable to employ a reference point formed of, or drawn with, a reflective material or a bright, fluorescent color, for example.

As used herein, “vehicle” includes any motorized vehicle, including, but not limited to, automobiles, vans, recreational vehicles, trucks, and buses. It is also contemplated that the reflective device of the present invention could be used in marinas to aid drivers in docking their boats.

The reflective device is secured to a stationary structure positioned a distance from the desired parking area. The stationary structure is a generally a wall (W) of an automobile garage or car port (G); however, it will recognized by one of ordinary skill in the art that the inventive mirror may be secured, within the appropriate location, to a building wall or structure of or near an open parking space found in condominium and apartment complexes, for example. Also, as discussed above, the inventive reflective device could be used to aid in the docking of boats in marinas by affixing the mirror(s) to front and/or side piers defining the boat slip, for example. For ease of explanation, however, the inventive method will be described in greater detail with respect to a parking garage or car port.

For use in a parking garage or car port (G), the vehicle (V) is initially parked at a desired position therein with the assistance of another person or by the driver alone through trial and error. FIG. 2 illustrates a top schematic view of a vehicle (V) parked within a garage or car port (G). Once the desired the position is found, the reflective device (10) is affixed to the side wall (W) of the garage or car port, for example, in such a way that the driver views the reference point (11) in a pre-selected alignment with the reflection of a pre-selected feature of the vehicle in the reflective surface (12). The driver then moves the vehicle into the desired parking area until he or she views the reflection of the pre-selected reference feature of the vehicle in a pre-determined alignment with the reference point. At this point, the vehicle is properly positioned, and thus the driver stops the vehicle.

By way of example only, as shown in FIG. 1, the reference line (11) essentially bisects the vehicle's (V¹) reflection and is aligned with the reflective rear end (20) of the door handle (21) on the driver's side (i.e. pre-selected reference feature). Other preselected reflective reference features of the vehicle (V¹) include, but are not limited to, a rear view mirror, vehicle radio antennae, rear or front wheel, and the like. Exemplary pre-selected alignments of the reference point and the pre-selected reference feature of the vehicle include, but are not limited to, bisecting or centering of the vehicle's door or door handle, bisecting or centering of the side door mirror, and the like.

FIG. 1 illustrates one embodiment of the invention wherein the reflective device is a 5.5 inch convex mirror having a ⅛ inch reference line (11) positioned down the center of the mirror (10). It is will be appreciated by those of ordinary skill in the art, however, that the mirror may be any variety of sizes and shapes.

The present invention may also be used to center or position a vehicle (V) properly between the two side walls (W) or posts of a parking garage or car port, respectively (FIG. 3). Here, the vehicle (V) is first positioned within the parking space at a desired parking area—in this case, a proper distance from the side walls (W)—either with the assistance of another person or by the driver alone through trial and error. Next, the reflective device (100) is affixed to the rear wall (R) of the garage (or similar support for a car port, open parking space, or boat slip, for example) such that the reflection of a pre-selected feature of the vehicle (V¹) is preferably centered (i.e. aligned) with respect to the reference point (110). A preferred method would be to position the reflective device (100) such that when the vehicle is properly parked, the reflection of the pre-selected feature of the vehicle is bisected by the reference point (110), such as a vertical line. It will be appreciated by those of ordinary skill in the art, however, that the reflective device (100) may be positioned such that the reference point (110) intersects other features of the vehicle's reflection (V¹) (e.g. a headlight, a side view mirror, a front tire, etc.). Moreover, as discussed above, reference points (110) other than a vertical line as shown in the figures may be employed, including other geometric shapes (e.g. circles, squares, triangles, etc.) that are drawn onto the reflective surface, adhesively affixed to the reflective surface, or etched into the reflective surface.

As shown in FIG. 2, one or more reflective devices (10, 100) may be employed within a selected parking space to aid in parking the vehicle in a desired position. For example, a reflective device (10) may be placed on one side wall (W) to aid in positioning the vehicle in an optimal spot with respect to the rear wall or post, for example, while a second reflective (100) may be placed on the rear wall (R) to aid in positioning the vehicle properly with respect to the side walls (W) or posts of the garage/car port (G).

The foregoing disclosure and description of the invention are illustrative and explanatory thereof, and various changes in the size, shape, and materials, as well as in the details of the illustrated construction may be made without departing from the spirit of the invention even though such variations were not specifically discussed above.

I claim:

1. A method for aiding a person in parking a vehicle within a desired parking area, said method comprising:
a. securing a reflective device to a stationary structure, said structure positioned a distance from said desired parking area, wherein said reflective device comprises a reflective surface and at least one reference point positioned on said surface;
b. moving a vehicle, driven by said person, toward said parking area until said person views a reflection from said device of a pre-selected reference feature of said vehicle in a pre-determined alignment with said at least one reference point; and
c. stopping said vehicle within said desired parking area.

2. The method of claim 1, wherein said reflective device is a mirror.

3. The method of claim 1, wherein said stationary structure is a wall.

4. The method of claim 1, wherein said at least one reference point includes a line, said line selected from the group of etched lines, affixed lines, and drawn lines.

5. The method of claim 1, wherein said at least one reference point includes a geometric shape, said geometric shape selected from the group of etched shapes, affixed shapes, and drawn shapes.

6. A method for aiding a person in parking a vehicle within a desired parking area, said vehicle having a passenger side and a driver side, and wherein said method comprises:
a. securing a reflective device to a stationary structure, said structure positioned a distance from said desired parking area such that when a vehicle is parked within said parking area, said reflective device is positioned adjacent either said passenger side or said driver side, and wherein said reflective device comprises a reflective surface and at least one reference point positioned on said surface;
b. moving a vehicle, driven by said person, toward said parking area until said person views a reflection from said device of a pre-selected reference feature of said vehicle in a pre-determined alignment with said at least one reference point; and
c. stopping said vehicle within said desired parking area.

7. The method of claim 6, wherein said reflective device is a mirror.

8. The method of claim 6, wherein said stationary structure is a wall.

9. The method of claim 6, wherein said at least one reference point includes a line, said line selected from the group of etched lines, affixed lines, and drawn lines.

10. The method of claim 6, wherein said at least one reference point includes a geometric shape, said geometric shape selected from the group of etched shapes, affixed shapes, and drawn shapes.

11. A method for aiding a person in parking a vehicle within a desired parking area, said vehicle having a front end, a passenger side, and a driver side, and wherein said method comprises:
a. securing a reflective device to a stationary structure, said structure positioned a distance from said desired parking area such that when a vehicle is parked within said parking area, said reflective device is positioned adjacent said front end of said vehicle, and wherein said reflective device comprises a reflective surface and at least one reference point positioned on said surface;
b. moving a vehicle, driven by said person, toward said parking area until said person views a reflection from said device of a pre-selected reference feature of said vehicle in a predetermined alignment with said at least one reference point; and
c. stopping said vehicle within said desired parking area.

12. The method of claim 11, wherein said reflective device is a mirror.

13. The method of claim 11, wherein said stationary structure is a wall.

14. The method of claim 11, wherein said at least one reference point includes a line, said line selected from the group of etched lines, affixed lines, and drawn lines.

15. The method of claim 11, wherein said at least one reference point includes a geometric shape, said geometric shape selected from the group of etched shapes, affixed shapes, and drawn shapes.

16. The method of claim 11, wherein (a) said securing includes securing a second reflective device to a second stationary structure, said second structure positioned a distance from said desired parking area such that when a vehicle is parked within said parking area, said second reflective device is positioned adjacent either said passenger side or said driver side of said vehicle, and wherein said second reflective device comprises a reflective surface and at least one reference point positioned on said surface; and (b) said moving includes moving said vehicle toward said parking area until said person views a reflection from said second reflective device of a second pre-selected reference feature of said vehicle in a second pre-determined alignment with said at least one reference point of said second reflective device.

17. The method of claim 16, wherein said second reflective device is a mirror.

18. The method of claim 16, wherein said second stationary structure is a wall.

19. The method of claim 16, wherein said at least one reference point of said second reflective device includes a line, said line selected from the group of etched lines, affixed lines, and drawn lines.

20. The method of claim 16, wherein said at least one reference point of said second reflective device includes a geometric shape, said geometric shape selected from the group of etched shapes, affixed shapes, and drawn shapes.
